(19) United States
(12) Patent Application Publication
(10) Pub. No.: US 2021/0317384 A1
(43) Pub. Date: Oct. 14, 2021

(54) FABRIC SOFTENER COMPOSITIONS

(71) Applicant: Taminco BVBA, Gent (BE)

(72) Inventors: Stijn Simonne Paul Van de Vyver, Gent (BE); Kristof Moonen, Hamme (BE); Robin Jacques Matton, Merelbeke (BE); Stefan geen Van der Burgh, Tiel (NL)

(73) Assignee: Taminco BVBA, Gent (BE)

(21) Appl. No.: 17/250,779

(22) PCT Filed: Sep. 16, 2019
(86) PCT No.: PCT/EP2019/074710

§ 371 Date: Mar. 3, 2021

(30) Foreign Application Priority Data
Sep. 19, 2018 (EP) 18195548.5

(51) Int. Cl. C11D 3/00; C11D 1/62; C11D 3/50; C11D 3/22

(52) U.S. Cl. CPC C11D 3/0015; C11D 3/221; C11D 3/502; C11D 1/62

(57) ABSTRACT

An aqueous fabric softener composition comprising from 0.01 to 10.0 wt. % of at least one fragrance fixative comprising at least one carbohydrate ester; from 0.01 to 10 wt. % of at least one fragrance; from 1.0 to 50.0 wt. % of at least one cationic surfactant; at least 45.0 wt. % of water; wherein the fragrance fixative is characterized by a cLogP value of equal to or greater than 1.5 and a boiling point from 200° C. to 350° C.; and wherein the carbohydrate ester comprises at least one ester group of formula —O—(C═O)—R₁ wherein R₁ is selected from C1-C6 alkyl or C1-C6 alkoxy groups; and whereby the weight percentages are expressed relative to the total weight of the composition (C).

### FIELD OF THE INVENTION

The present invention relates to fabric softener compositions providing a prolonged fragrance release from the dry laundered fabric over an extended period of time.

### BACKGROUND OF THE INVENTION

Fabric softener compositions are well known in the art and are generally used during the rinse cycle or drying cycle of a typical laundry process to provide improved softness and freshness to the laundered fabric articles. To provide this freshness, fragrances are added to fabric softener compositions. Fragrance delivery and longevity on laundered fabric articles are important features of these fabric softener compositions to provide a dean impression of the product itself, as well as of the fabric treated with the product. Although the fragrance does not enhance the performance of a fabric softener composition, the fragrance makes these products more aesthetically pleasing, and consumers expect and demand a pleasing odor for such products. Many consumers desire the fragrance to be deposited onto the fabric and remain on the fabric for an extended period of time to convey a continuing impression of freshness. Consumers further desire fabric softener compositions which impart a sufficient fragrance level to the fabric and/or which release the fragrance when the fabric is ironed.

Introduction of a fragrance into a fabric softener composition is restricted by considerations such as availability, cost and by the ability of the fragrance to sufficiently deposit onto a fabric and then remain on the fabric during the wash, rinse, and drying cycles. In the current commercially available fabric softener compositions, a substantial amount of the fragrance is lost during rinse cycles due to the water solubility of various fragrance ingredients. Furthermore, a substantial amount of the fragrance deposited on a fabric is removed from the fabric during the drying process, even when the treated fabrics are line dried. This fragrance loss is attributed to the volatility of fragrance ingredients deposited on the fabric.

Various attempts have been made to increase fragrance deposition onto fabric and to hinder or delay the release of the fragrance so that the laundered fabric remains aesthetically pleasing for a prolonged period of time. Generally, these attempts center around the use of carrier and/or encapsulation materials to improve deposition of the fragrance onto the fabric, around the proper selection of the fragrance ingredients or around controlling the rate of release of the fragrance, for example by using fragrance fixatives.

Fragrance fixatives impart increased stability to the fragrance and slow down and match the evaporation of the individual fragrance ingredients such that the fragrance is released over an extended period of time while the fragrance profile remains the same. The effect of most of the known fragrance fixatives is based on a reduced volatility of the fragrance by the reduction in vapor pressure of the fragrance ingredients, for example by dipole formation, hydrogen bridge bonding, adsorption effects or the formation of azeotropic mixtures. The use of fragrance fixatives is well known and widely described in the art. For instance, US 2008/0054089 A1 describes the use of C₄ to C₈ alkyl terephthalates as fragrance fixatives in scented compositions such as fabric softeners. U.S. Pat. No. 6,737,396 describes a perfume composition which may be used in fabric softeners and is formed by mixing 2-30%, relative to the weight of the composition, of the fixative (1 -ethoxyethoxy)cyclododecane, to fix or exalt musky or aromatic-type notes. U.S. Pat. No. 7,196,052 describes fragrance compositions which may be used in softeners and which contain glycerol ether derivatives as fixatives or fragrance note-improving agents.

However, not all known fragrance fixatives are satisfactory as they often require additional attention at the formulation process and increase costs.

Furthermore, most known fragrance fixatives are insoluble in aqueous systems. Another concern with some of the existing fragrance fixatives is that they provide a woody or musky odor and therefore may not be suitable to fixate certain fragrance compositions.

Next to fragrance fixatives, another approach is to select fragrances with the inherent property of endurance or longevity. U.S. Pat. No. 5,500,138 describes fabric softener compositions combined with highly enduring substantive perfumes which have a low rinse water solubility. US 5,500,138 mainly defines these perfumes in terms of their boiling point and their cLogP value, the calculated log value of the octanol/water partitioning coefficient which gives an indication of hydrophobicity. U.S. Pat. No. 5,500,138 discloses that when perfume compositions which are composed mainly of ingredients with a boiling point at about 250° C. or higher and a cLogP of about 3 or higher are used in softener compositions, the perfume is very effectively deposited on fabrics and remains substantive on fabrics after the rinsing and drying steps. Said fabric softener compositions may also comprise fatty acid partial esters of polyhydric alcohols such as sucrose wherein the fatty acid portion of the ester is derived from fatty acids having 12 to about 30, preferably from about 16 to about 20, carbon atoms. Said polyhydric alcohols are used as nonionic softeners and are present in the fabric softener compositions in an amount from 0.5% to about 10%, preferably from about 1% to about 5%. The disadvantage of the fabric softener compositions described in U.S. Pat. No. 5,500,138 is that only a limited amount of perfumes or fragrance ingredients can be used.

In view of the above, there is a continuous need for improved fabric softener compositions having an improved and more efficient fragrance deposition and fragrance longevity, in particular having a prolonged fragrance release from the dry laundered fabric over an extended period of time.

### SUMMARY OF THE INVENTION

The inventors have now surprisingly found that it is possible to provide an improved fabric softener composition fulfilling the above-mentioned needs. Thus, there is now provided an aqueous fabric softener composition [composition (C), herein after] comprising:
from 0.01 to 10.0 wt. % of at least one fragrance fixative comprising at least one carbohydrate ester;
from 0.01 to 10 wt. % of at least one fragrance;
from 1.0 to 50.0 wt. % of at least one cationic surfactant;
at least 45.0 wt. % of water;
wherein the fragrance fixative is characterized by a cLogP value of equal to or greater than 1.5 and a boiling point from 200° C. to 350° C.; and wherein the carbohydrate ester comprises at least one ester group of formula —O—(C═O)—R₁ wherein R₁ is selected from C1-C6 alkyl or C1-C₆ alkoxy groups;
and whereby the weight percentages are expressed relative to the total weight of the composition (C).

In another aspect the present invention further provides a method for the manufacturing of the fabric softener composition, as detailed above, and the use of the fabric softener composition, as detailed above.

### DETAILED DESCRIPTION

### Composition (C)

Thus, the aqueous fabric softener composition [composition (C), herein after] according to the present invention comprises from 0.1 to 10.0 wt. % of at least one fragrance fixative comprising at least one carbohydrate ester, as detailed above.

The inventors have surprisingly found that by using at least one fragrance fixative, as detailed above, comprising at least one carbohydrate ester, as detailed above, in combination with at least one fragrance, and at least one cationic surfactant, the resulting composition (C) is very effective in depositing the fragrance onto a fabric, that the fragrance longevity is increased and in particular that the fragrance is released from the dry laundered fabric over an extended period of time. The applicants have found that the fragrance fixatives, as detailed above, will improve the fragrance deposition and longevity of a wide range of fragrances, as demonstrated in the working examples.

Within the context of the present invention, the expressions “at least one fragrance fixative” and “at least one carbohydrate ester” are intended to denote one or more than one fragrance fixative and one or more than one carbohydrate ester, respectively. Mixtures of fragrance fixatives and carbohydrate esters may be used.

In the rest of the text, the expressions “fragrance fixative” and “carbohydrate ester” are understood, for the purposes of the present invention, both in the plural and the singular form.

In the context of the present invention, the term “fragrance fixative” is intended to denote substances which impart an increased stability to the fragrance and slow down and match the evaporation of the individual fragrance ingredients such that the fragrance is released over an extended period of time while the fragrance profile remains the same.

As said, the weight percent of the at least one fragrance fixative, relative to the total weight of composition (C) is advantageously equal to or greater than 0.01 wt. %, or equal to or greater than 0.05 wt. %, or equal to or greater than 0.1 wt. %.

It is further understood that the upper limit of the weight percent of the at least one fragrance fixative, relative to the total weight of composition (C) is equal to or less than 10.0 wt. %, or equal to or less than 7.5 wt. %, or equal to or less than 5.0 wt. %, or equal to or less than 4.0 wt. %, or equal to or less than 2.5 wt. %.

In a preferred embodiment of the composition (C) according to the present invention, the weight percent of the at least one fragrance fixative, relative to the total weight of the composition (C), ranges from 0.01 to 10.0 wt. %, or 0.1 to 5.0 wt. %.

As said, the cLogP value of the at least one fragrance fixative is equal to or greater than 1.5, or equal to or greater than 1.65, or equal to or greater than 1.75, or equal to or greater than 1.85, or equal to or greater than 1.95, or equal to or greater than 2.0.

It is further understood that the upper limit of the cLogP value of the at least one fragrance fixative is not particularly limited but advantageously equal to or lower than 10.0, or equal to or lower than 9.5, or equal to or lower than 9.0, or equal to or lower than 8.5.

In a preferred embodiment of the composition (C) according to the present invention, the cLogP value of the at least one fragrance fixative ranges from 1.5 to 10.0, or from 1.75 to 9.0, or from 1.95 to 8.5.

As said, the cLogP value of a compound is the calculated logarithm of the partition coefficient of said compound between octanol and water. The higher the cLogP value the greater the hydrophobicity. The cLogP value of the fragrance fixative can be calculated from the molecular structure of the fragrance fixative by using commercially available software such as ChemDraw

Professional 17 Suite available from PerkinElmer Informatics.

As said, the boiling point of at least one fragrance fixative is equal to or greater than 200° C., or equal to or greater than 210° C., or equal to or greater than 220° C., or equal to or greater than 230° C., or equal to or greater than 240° C., or equal to or greater than 245° C., or equal to or greater than 250° C.

It is further understood that the upper limit of the boiling point of the at least one fragrance fixative, is equal to or less than 350° C., or equal to or less than 340° C., or equal to or less than 330° C., or equal to or less than 320° C., or equal to or less than 310° C., or equal to or less than 305° C., or equal to or less than 300° C.

In a preferred embodiment of the composition (C) according to the present invention, the boiling point of the at least one fragrance fixative ranges from 200° C. to 350° C., or from 220° C. to 330° C., or from 240° C. to 310° C.

The boiling point of the fragrance fixative can be determined according to standard practice, for example by using thermal analysis methods such as differential scanning calorimetry in crucibles sealed with a pierced lid.

In a preferred embodiment of the composition (C) according to the present invention, the weight percent of the at least one carbohydrate ester, as detailed above, relative to the total weight of the fragrance fixative, is advantageously at least 80 wt. %, or at least 85 wt. %, or at least 90 wt. %, or at least 95 wt. % or at least 98 wt. %,

Still, it is generally preferred that the fragrance fixative consists essentially of at least one carbohydrate ester, as detailed above.

For the purpose of the present invention, the expression “consists essentially of” is intended to denote that any additional ingredient different from the at least one carbohydrate ester, as detailed above, is present in minor amounts in said fragrance fixative, being understood that these latter do not substantially modify the properties of said fragrance fixative.

It is understood that the at least one carbohydrate ester in the fragrance fixative is selected in such a way that the requirements for the fragrance fixative in terms of cLogP and boiling point, as detailed above, are complied with. It is further understood that in case the fragrance fixative consists essentially of at least one carbohydrate ester, as detailed above, that this carbohydrate ester or mix of carbohydrate esters also needs to comply with the requirements in terms of cLogP and boiling point as defined for the fragrance fixative, as detailed above.

In the context of the present invention, the term “carbohydrate ester” is intended to denote ester derivatives of cyclic carbohydrates, said derivative resulting from at least one of the hydroxyl groups in said cyclic carbohydrates being esterified so that the carbohydrate ester comprises at least one ester group of formula —O—(C═O)—R₁ wherein R₁ is selected from C1-C6 alkyl or C1-C6 alkoxy groups. It is understood that the term “carbohydrate ester” thereby includes carbohydrate partial esters such as carbohydrate mono, di, tri, tetra, penta, hexa, hepta, octo, . . . esters wherein the prefixes indicate the average degree of esterification, as well as fully esterified carbohydrates (100%), unless mentioned otherwise, The carbohydrate ester may exist as a mixture of carbohydrate esters ranging from the carbohydrate monoester to the fully esterified carbohydrate, unless mentioned otherwise.

In the context of the present invention, the term “cyclic carbohydrates” is intended to denote monosaccharides, disaccharides, trisaccharides or higher polysaccharides where the saccharide exists in the form of a pyranose or a furanose (6- or 5-member rings). Non-limiting examples of cyclic carbohydrates include inositol, glucose, xylose, arabinose, galactose, fructose, sorbose, sucrose, lactose, cellobiose, lactulose, maltose, trehalose, mannobiose, melibiose, melibiulose, rutinose, cellotriose, maltotriose, melezitose and raffinose and the like.

In a preferred embodiment of the composition (C) according to the present invention, the fragrance fixative consists essentially of carbohydrate esters of general formula I:

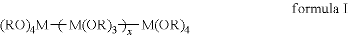

wherein:
each of M is independently selected and at each occurrence from monosaccharides in the pyranose or furanose form;
x is an integer in the range from 0 to 4;
each of R is independently selected and at each occurrence from —H or —(C═O)—R₁ wherein R₁ is selected from C1-C6 alkyl or C1-C6 alkoxy groups, with the proviso that at least one R is —(C═O)—R₁.

If desired, the fragrance fixative is a carbohydrate ester of general formula I, as detailed above.

Non-limiting examples of suitable monosaccharides in the pyranose or furanose form include glucose, galactose, fructose, ribose, xylose, arabinose and sorbose.

As will be understood by the person skilled in the art, the monosaccharides M in general formula I are connected through a glycosidic bond.

In a preferred embodiment of the composition (C) according to the present invention, each of R₁, is independently selected and at each occurrence from an alkyl group having from 1 to 6 carbon atoms, or from 1 to 4 carbon atoms, or each of R₁, equal to or different from each other, is independently selected from methyl, ethyl, propyl, isopropyl, n-butyl, s-butyl, t-butyl or isobutyl. Desirably, each of R₁, equal to or different from each other, is independently selected from methyl, ethyl, propyl, n-butyl or isobutyl.

In a preferred embodiment of the composition (C) according to the present invention, x in general formula I is an integer in the range from 0 to 2, or from 0 to 1. Desirably, x is 0.

In a preferred embodiment of the present invention, the fragrance fixative consists of carbohydrate esters wherein in at least 80% of the available OR groups R is —(C═O)—R₁, or at least 85%, or at least 90%, or at least 95%, or at least 97%, or at least 98%, or at least 99%.

It is further understood that all definitions and preferences, as described above, equally apply for all further embodiments, as described below. In a more preferred embodiment of the composition (C) according to the present invention, the fragrance fixative consists essentially of carbohydrate esters of formula II:

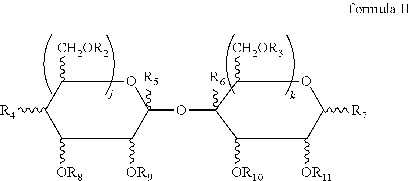

wherein:
each of R₁, R₂, R₃, R₈, R₉, R₁₀ and R₁₁ is independently selected and at each occurrence from —H or —(C═O)—R₁;
j and k are integers in the range of 0 to 1;
when j is 1, R₅ is —H and R₄ is OR₁₂ wherein R₁₂ is independently selected and at each occurrence from —H or —(C═O)—R₁;
when j is 0, R₄ is —CH₂OR₁₄ and R₅ is —CH₂OR₁₅ wherein R₁₄ and R₁₅ are independently selected and at each occurrence from —H or —(C═O)—R₁;
when k is 1, R₆ is —H and R₇ is OR₁₃ wherein R₁₃ is independently selected and at each occurrence from —H or —(C═O)—R₁;
when k is 0, R₆ is —CH₂OR₁₆ and R₇ is —CH₂OR₁₇ wherein R₁₆ and R₁₇ are independently selected and at each occurrence from —H or —(C═O)—R₁;
and wherein R₁ is selected from C1-C6 alkyl or C1-C6 alkoxy groups,
with the proviso that at least one of R₂, R₃, R₈, R₉, R₁₀, R₁₁, R₁₂, R₁₃, R₁₄, R₁₅, R₁₆ and R₁₇ is —(C═O)—R₁.

If desired, the fragrance fixative is a carbohydrate ester of formula H, as detailed above.

In a preferred embodiment of the composition (C) according to the present invention, when at least two of R₂, R₃, R₃, R₉, R₁₀, R₁₁, R₁₂, R₁₃, R₁₄, R₁₅, R₁₆ and R₁₇ are —(C═O)—R₁ each of R₁ is independently selected from C1-C6 alkyl or C1-C6 alkoxy groups with the proviso that at least two R₁ groups are different from each other.

According to one embodiment of the present invention, the fragrance fixative consists essentially of carbohydrate esters of formula HI [carbohydrate esters of class (I), herein after]:

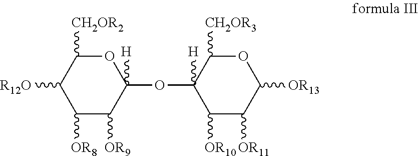

with the proviso that at least one of R₂, R₃, R₅, R₉, R₁₀, R₁₁, R₁₂ and R₁₃ is —(C═O)—R₁;

wherein R₁, R₂, R₃, R₅, R₉, R₁₀, and R₁₃ have the same meaning as defined above for formula H.

If desired, the fragrance fixative is a carbohydrate ester of formula III, as detailed above.

According to one embodiment of the present invention, the fragrance fixative consists essentially of carbohydrate esters of formula IV [carbohydrate esters of class (II), herein after]:

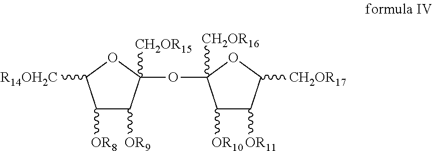

with the proviso that at least one of R₈, R₉, R₁₀, R₁₁, R₁₄, R₁₅, R₁₆ and R₁₇ is —(C═I)—R₁;

wherein R₁, R₈, R₉, R₁₀, R₁₁, R₁₄, R₁₅, R₁₆ and R₁₇ have the same meaning as defined above for formula H.

If desired, the fragrance fixative is a carbohydrate ester of formula IV, as detailed above.

According to one embodiment of the present invention, the fragrance fixative consists essentially of carbohydrate esters of formula V [carbohydrate esters of class (III), herein after]:

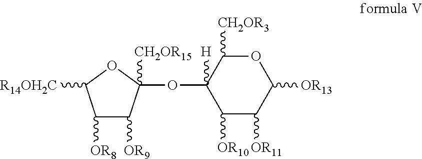

with the proviso that at least one of R₃, R₈, R₉, R₁₀, R₁₁, R₁₃, R₁₄ and R₁₅ is —(C═O)—R₁;

wherein R₁, R₃, R₈, R₉, R₁₀, R₁₁, R₁₃, R₁₄ and R₁₅ have the same meaning as defined above for formula II.

If desired, the fragrance fixative is a carbohydrate ester of formula V, as detailed above.

According to a preferred embodiment of the present invention, the fragrance fixative consists essentially of carbohydrate esters of formula VI [carbohydrate esters of class (IV), herein after];

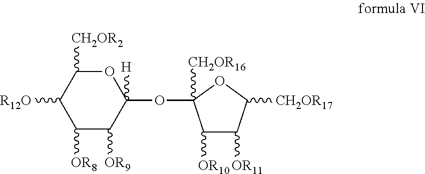

with the proviso that at least one of R₂, R₈, R₉, R₁₀, R¹¹, R₁₂, R₁₆ and R₁₇ is —(C═O)—R₁;

wherein R₁, R₂, R₈, R₉, R₁₀, R₁₁, R₁₂, R₁₆ and R₁₇ have the same meaning as defined above for formula II.

If desired, the fragrance fixative is a carbohydrate ester of o ula VI, as detailed above.

The carbohydrate esters for use in the present invention, as detailed above, have several centers of chirality and exist as stereochemically isomeric forms. The term “stereochemically isomeric forms” as used herein defines all the possible compounds made up of the same atoms bonded by the same sequence of bonds but having different three-dimensional structures. The wavy bonds in the carbohydrate esters, as detailed above, indicate that the configuration is undefined and that both an R or S configuration may be adopted.

Unless otherwise mentioned or indicated, the chemical designation of the compounds for use, as detailed above, encompasses the mixture of all possible stereochemically isomeric forms, which said compounds for use may possess. Said mixture may contain all diastereomers and/or enantiomers of the basic molecular structure of said compounds for use. All stereochemically isomeric forms of the compounds of the present invention both in pure form or mixed with each other are intended to be embraced within the scope of the present invention.

Preferred carbohydrate esters of class (IV), for use in the composition (C) according to the present invention are those of formula VI-a herein below:

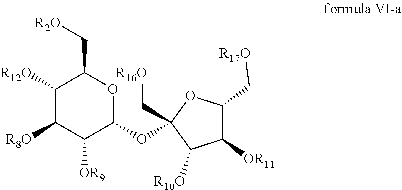

wherein:
each of R₂, R₈, R₉, R₁₀, R₁₁, R₁₂, R₁₆ and R₁₇ are independently selected and at each occurrence from —H or —(C═O)—R₁;
R₁ is selected from C1 -C6 alkyl or C1-C6 alkoxy groups; with the proviso that at least one of R₂, R₈, R₉, R₁₀, R₁₁, R₁₂, R₁₆ and R₁₇ is —(C═O)—R₁.

Non-limiting examples of suitable carbohydrate esters of formula VI-a include: sucrose octoisobutyrate, sucrose heptaisobutyrate acetate, sucrose hexaeisobutyrate diacetate, sucrose pentaisobutyrate triacetate, sucrose tetraisobutyrate tetraacetate, sucrose triisobutyrate pentaacetate.

In a preferred embodiment of the composition (C) according to the present invention, each of R₁ in formula VI-a, is independently selected and at each occurrence from an alkyl group having from 1 to 6 carbon atoms, or from 1 to 4 carbon atoms, or each of R₁, equal to or different from each other, is independently selected from methyl, ethyl, propyl, isopropyl, n-butyl, s-butyl, t-butyl or isobutyl. Desirably, each of R₁, equal to or different from each other, is independently selected from methyl, ethyl, propyl, n-butyl or isobutyl.

In a preferred embodiment of the present invention, at least two of R₂, R₈, R₉, R₁₀, R₁₁, R₁₂, R₁₆ and R₁₇ in formula VI-a is —(C═O)—R₁, or at least three, or at least four, or at least five, or at least six, or at least seven. Desirably, all of R₂, R₃, R₉, R₁₀, R₁₁, R₁₂, R₁₆ and R₁₇ in formula VI-a are —(C═O)—R₁.

Without being bound to this theory, the Applicants believe that a high number of ester groups may protect the glycosidic bond in the carbohydrate ester and may thereby provide a higher long-term stability of the carbohydrate esters, as detailed above.

In a more preferred embodiment of the present invention, the fragrance fixative consists essentially of carbohydrate esters of formula VI-a wherein all of R₂, R₈, R₉, R₁₀, R₁₁, R₁₂, R₁₆ and R₁₇ in formula VI-a are —(C═O)—R₁, wherein R₁ is selected from methyl or isobutyl, with the proviso that at least one R₁ is isobutyl.

It is understood that the term “carbohydrate esters” encompasses mixtures of carbohydrate esters which comprise different substituents. Specifically, the fully esterified carbohydrate esters as mentioned in the embodiment right above, may be a mixture of carbohydrate esters which mixture for example comprises carbohydrate esters having eight isobutyrate groups as well as carbohydrate esters having two acetate groups and six isobutyrate groups and possibly other homologues having a different ratio of ester group substituents.

The synthesis of suitable carbohydrate esters, as detailed above, is well known in the art, such as notably described in U.S. Pat. Nos. 3,096,324 and 6,977,275, the whole content of which is herein incorporated by reference.

A non-limitative example of a commercially available carbohydrate ester suitable for use in the composition (C) according to the present invention is sucrose acetate isobutyrate, SAIF-100 available from Eastman Chemical Company which can be prepared using known techniques by reacting sucrose with acetic and isobutyric anhydrides followed by extensive purification using high vacuum distillation, The approximate ratio of acetate:isobutyrate ester groups in SAIB-100 is 2:6.

Thus, the composition (C) according to the present invention comprises from 0.01 to 10.0 wt. % of at least one fragrance.

Within the context of the present invention, the expression “at least one fragrance” is intended to denote one or more than one fragrance. In the rest of the text, the expression “fragrance” is understood, for the purposes of the present invention, both in the plural and the singular form.

As said, the weight percent of the at least one fragrance, relative to the total weight of composition (C) is advantageously equal to or greater than 0.01 wt. %, or equal to or greater than 0.02 wt. %, or equal to or greater than 0.05 wt. %, or equal to or greater than 0.1 wt. %, or equal to or greater than 015 wt. %, or equal to or greater than 0.2 wt. %.

It is further understood that the upper limit of the weight percent of he at least one fragrance is equal to or less than 10.0 wt. %, or equal to or less than 8.0 wt. %, or equal to or less than 6.0 wt. %, or equal to or less than 4.0 wt. %, or equal to or less than 2.0 wt. %.

In a preferred embodiment of the composition (C) according to the present invention, the weight percent of the at least one fragrance, relative to the total weight of composition (C) ranges from 0.01 to 10.0 wt. %, or from 0.05 to 5.0 wt. %, or from 0,5 to 2.0 wt. %.

It is understood that the composition (C) according to the present invention may contain all kinds of fragrances of natural and/or synthetic origin. These fragrances are well known to the person skilled in the art of perfuming and/or aromatizing consumer products and are described in detail in for example Perfume Flavors and Chemicals, Volume I and H by S. Arctander (1969) and Ullmann's Encyclopedia of Industrial Chemistry, Laundry Detergents by Smulders, E. et al, (2007).

Suitable fragrances for use in the composition (C) according to the present invention include, but are not limited to: aldehyde fragrances, ketone fragrances, Schiff-Bases and other natural, synthetic or artificial fragrances such as the perfume ingredients and fragrances notably described in U.S. Pat. No. 7,601,681 B2.

To decrease the rinse water solubility of the fragrance and hence to increase the fragrance deposition and longevity, highly water-soluble fragrances are preferably to be avoided. The aqueous solubility of a fragrance may be determined from the calculated octanol/water partition coefficient of the fragrance which is expressed as cLogR cLogP may be calculated from the molecular structure of the fragrance in a similar manner as for the carbohydrate ester fragrance fixative, as explained above. In general, the higher the cLogP value, the greater the longevity of the fragrance.

In a preferred embodiment of the composition (C) according to the present invention, at least 20.0 wt. % of fragrances, or at least 40.0 wt. %, or at least 60.0 wt. %, or at least 70.0 wt. %, or at least 80.0 wt. % of fragrances in the composition (C) are having a cLogP equal to or greater than 2.0, or equal to greater than 2.5, or equal to greater than 2.75, or equal to greater than 3.0.

Non-limiting examples of suitable fragrances having a cLogP value of equal to or greater than 2.0 notably include: Iso E super, citronellol, ethyl cinnamate, bangalol, 2,4,6-trimethylbenzaldehyde, hexyl cinnamic aldehyde, 2,6-dimethyl-2-heptanol, diisobutylcarbinol, para-cymene, dihydro myrcenol, ethyl salicylate, phenethyl isobutyrate, ethyl hexyl ketone, propyl amyl ketone, dibutyl ketone, heptyl methyl ketone, 4,5-dihydrotoluene, caprylic aldehyde, citral, geranial, isopropyl benzoate, cyclohexanepropionic acid, laevo-carvone, campholene aldehyde, caprylic acid, caprylic alcohol, cuminaldehyde, 1-ethyl-4-nitrobenzene, heptyl formate, 4-isopropylphenol, 2-lsopropylphenol, 3-isopropylphenol, allyl disulfide, 4-methyl-1-phenyl-2-pentanone, 2-propylfuran, allyl caproate, styrene, isoeugenyl methyl ether, indonaphthene, diethyl suberate, I-menthone, menthane racemic, p-cresyl isobutyrate, butyl butyrate, ethyl hexanoate, propyl valerate, n-pentyl propanoate, hexyl acetate, methyl heptanoate, trans-3,3,5-trimethylcyclohexanol, 3,3,5-trimethylcyclohexanol, ethyl p-anisate, 2-ethyl-1 -hexanol, benzyl isobutyrate, 2,5-dimethylthiophene, isobutyl 2-butenoate, caprylnitrile, gamma-nonalactone, delta-nonalactone, iso-bornyl acetate, carvacrol, nerol, geraniol, cis- jasmone, indole, methyl dihydrojasmonate, 1-vinylheptanol, eucalyptol, 4-terpinenol, dihydrocarveol, ethyl 2-methoxybenzoate, ethyl cyclohexanecarboxylate, 2-ethylhexanal, ethyl amyl carbinol, 2-octanol, 2-octanol, ethyl methylphenylglycidate, diisobutyl ketone, coumarone, propyl isovalerate, isobutyl butanoate, isopentyl propanoate, 2-ethylbutyl acetate, 6-methyl-tetrahydroquinoline, eugenyl methyl ether, ethyl dihydrocinnamate, 3,5-dimethoxytoluene, toluene, ethyl benzoate, n- butyrophenone, alpha-terpineol, geranyl acetate, linalyl acetate, Vertenex, d-limonene, methyl 2-methylbenzoate, methyl 4-methylbenzoate, methyl 3, methylbenzoate, sec. butyl n-butyrate, 1 ,4-cineole, fenchyl alcohol, pinanol, cis-2-pinanol, 2,4, dimethylacetophenone, eugenol, isoeugenol, safrole, methyl 2-octynoate, o-methylanisole, p-cresyl methyl ether, methyl-n-methyl anthranilate, ethyl anthranilate, linalool, phenyl butyrate, ethylene glycol dibutyrate, diethyl phthalate, phenyl mercaptan, cum ic alcohol, m-toluquinoline, 6-methylquinoline, lepidine, 2-ethylbenzaldehyde, 4-ethylbenzaldehyde, o-ethylphenol, p-ethylphenol, m-ethylphenol, (+)-pulegone, 2,4-dirnethylbenzaldehyde, isoxylaldehyde, ethyl sorbate, benzyl propionate, 1 ,3-dimethylbutyl acetate, isobutyl isobutanoate, 2,6-xylenol, 2,4-xylenol, 2,5-xylenol, 3,5-xylenol, methyl cinnamate, hexyl methyl ether, benzyl ethyl ether, methyl salicylate, butyl propyl ketone, ethyl amyl ketone, hexyl methyl ketone, 2,3-xylenol, 3,4, xylenol, cyclopentadenanolide and phenylethyl 2-phenylacetate.

It is common for a plurality of fragrances to be present in a fabric softener composition. Preferably, the composition (C) of the present invention comprises two or more, preferably three or more, more preferably four or more, more preferably five or more, more preferably six or more or even seven or more different fragrances.

The vapor pressure and the boiling point of a fragrance, which are related, are also important parameters to ensure that the fragrance does not evaporate during the rinse cycle to which the composition (C) is added, and that it survives the drying process ensuring that sufficient fragrance is present to provide a lasting scent on the dry fabric. High-boiling fragrances will evaporate more slowly, giving a longer lasting fragrance perception. Vapor pressure and boiling point may be calculated using one of the commercially available software programs, such as ACD Software ACD/Boiling Point calculator version 4.0. Alternatively, the boiling point and vapor pressure may be measured by thermal analysis, for example according to ASTM E1782. In addition to calculating or measuring vapor pressures and boiling points, both can be found in various reference books such as CRC Handbook of Chemicals and Physics, various editions; and Chemical Properties Handbook, Yaw, Carl L., editor; McGraw-Hill Publishing Company, 1999.

In one embodiment of the composition (C) according to the present invention, at least 20.0 wt. % of fragrances or at least 40.0 wt. %, or at least 60.0 wt. %, or at least 70.0 wt. %, or at least 80.0 wt. % of fragrances in the composition (C) are having a vapor pressure at 20° C. equal to or greater than 0.0001 Pa, or equal to or greater than 0.01 Pa, or equal to or greater than 1 Pa, or equal to or greater than 10 Pa, or equal to or greater than 20 Pa, or equal to or greater than 50 Pa.

In a preferred embodiment of the composition (C) according to the present invention, at least 20,0 wt. % of fragrances or at least 40.0 wt. %, or at least 60.0 wt. %, or at least 70.0 wt. %, or at least 80.0 wt. % of fragrances in the composition (C) are having a boiling point equal to or greater than 200° C., or equal to or greater than 225° C., or equal to or greater than 235° C., or equal to or greater than 245° C., or equal to or greater than 250° C.

Non-limiting examples of suitable fragrances having a cLogP value of equal to or greater than 2.0 and a boiling point equal to or greater than 250° C. notably include: allyl cyclohexane propionate, ambrettolide, amyl benzoate, amyl cinnamate, amyl cinnamic aldehyde, amyl cinnamic aldehyde dimethyl acetal, iso-amyl salicylate, Aurantiol (trade name for hydroxy-citronellal-methylanthranilate), benzophenone, benzyl salicylate, para-tert-butyl cyclohexyl acetate, iso-butyl quinolone, beta-caryophyllene, cadinene, cedrol, cedryl acetate, cedryl formate, cinnamyl cinnamate, cyclohexyl salicylate, cyclamen aldehyde, dihydro isojasmonate, diphenyl methane, diphenyl oxide, dodecalactone, iso E super (trade name for 1-(1,2,3,4,5,6,7,8-octahydro-2,3,8,8-tetramethyl-2-naphthalenyl)-ethanone), betal-methyl naphthyl ketone, ethylene brassylate, ethyl methyl phenyl glycidate, ethyl undecylenate, Exaltolide (trade name for 15-hydroxyentadecanoic acid, lactone), Galaxolide (trade name for 1,3,4,6,7,8-hexahydro-4,6,6,7,8,8-hexamethylcyclopenta-gamma-2-benzopyran), eugenol, iso-eugenol, indole, methyl cinnamate, methyl dihydrojasmonate, methyl-n-methyl anthranilate, beta-methyl naphthyl ketone, delta-nonalactone, geranyl anthranilate, geranyl phenyl acetate, hexadecanolide, hexenyl salicylate, hexyl cinnamic aldehyde, hexyl salicylate, alpha-irone, Lilial (trade name for para-tertiary-butyl-alpha-methyl hydrocinnamic aldehyde), linalyl benzoate, 2-methoxy naphthalene, methyl dihydrojasmone, gamma-n-methyl ionone, musk indanone, musk ketone, musk tibetine, myristicin, oxahexadecanolide-10, oxahexadecanolide-11, patchouli alcohol, Phantolide (trade name for 5-acetyl-1,1,2,3,3,6-hexamethyl indan), phenyl ethyl benzoate, phenylethylphenylacetate, phenyl heptanal, phenyl hexanol, alpha-santalol, Thibetolide (trade name for 15-hydroxypentadecanoic acid, lactone), delta-undecalactone, gamma-undecalactone, vetiveryl acetate, yara-yara, ylangene.

As said, it is known that fragrances with a higher cLogP and a higher boiling point already show an improved fragrance longevity. The applicants have now surprisingly found that when these particular fragrances are combined with the fragrance fixative, as detailed above, the effect of fragrance deposition and fragrance longevity of the composition (C) is improved even further, as demonstrated in the working examples.

In an alternative embodiment of the composition (C) according to the present invention, the average cLogP value of all the fragrances in the composition (C) is equal to or greater than 2.0, or equal to greater than 2.5, or equal to greater than 2.75, or equal to greater than 3.0.

The average cLogP value is determined by adding up the cLogP values of all the fragrances in the composition (C) and dividing by the number of fragrances.

Thus, the composition (C) according to the present invention comprises from 1.0 to 30.0 wt. % of at least one cationic surfactant.

Within the context of the present invention, the expression “at least one cationic surfactant” is intended to denote one or more than one cationic surfactant.

In the rest of the text, the expression “cationic surfactant” is understood, for the purposes of the present invention, both in the plural and the singular form.

As said, the weight percent of the at least one cationic surfactant, relative to the total weight of composition (C), is equal to or greater than 0.01 wt. %, or equal to or greater than 0.05 wt. %, or equal to or greater than 0.1 wt. %, or equal to or greater than 0.2 wt. %, or equal to or greater than 0.5 wt. %, or equal to or greater than 1.0 wt. %.

It is further understood that the weight percent of the at least one cationic surfactant, relative to the total weight of composition (C), is equal to or less than 50.0 wt. %, or equal to or less than 45.0 wt. %, or equal to or less than 40.0 wt. %, or equal to or less than 35.0 wt. %, or equal to or less than 30.0 wt. %.

In a preferred embodiment of the composition (C) according to the present invention, the weight percent of the at least one cationic surfactant, relative to the total weight of composition (C), ranges from 0.01 to 50 wt. %, or from 0.2 to 40 wt, %, or from 1.0 to 30 wt. %,

Cationic surfactants suitable for use in the composition (C) according to the present invention are well known to a person skilled in the art of fabric softener formulation. Suitable cationic surfactants are notably described in Cationic Surfactants, Surfactant Science series, Volume 34, edited by Richmond J. M., Marcel Dekker Inc. 1990.

In one embodiment of the composition (C) according to the present invention, the cationic surfactant is a cationic quaternary ammonium salt wherein the counter ion may be a halide, such as chloride or bromide, methyl sulfate, formate, sulfate, nitrate or other suitable ions compatible with fabric softener compositions and well known in the literature.

Examples of cationic quaternary ammonium salts include but are not limited to: acyclic quaternary ammonium salts, cyclic quaternary ammonium salts of the imidazolinium type, diamido quaternary ammonium salts and biodegradable quaternary ammonium salts,

Non-limiting examples of suitable acyclic quaternary ammonium salts include acyclic quaternary ammonium salts having at least two CE3 to C30, preferably C12 to C22 alkyl or alkenyl chains, such as: ditallowdimethyl ammonium methylsulfate, di(hydrogenated tallow)dimethyl ammonium methylsulfate, di(hydrogenated tallow)dimethyl ammonium chloride, distearyldimethyl ammonium methyl-sulfate, dicocodirnethyl ammonium methylsulfate and the like.

Non-limiting examples of suitable cyclic quaternary ammonium salts of the imidazolinium type include di(hydrogenated tallow)dimethyl imidazolinium methylsulfate, 1-ethylene-bis(2-tallow-1-methyl) imidazolinium methylsulfate and the like,

Non-limiting examples of suitable diarnido quaternary ammonium salts include methyl-bis(hydrogenated tallow am idoethyl)-2-hydroxethyl ammonium methyl sulfate, methyl bi(tallowamidoethyl)-2-hydroxypropyl ammonium methylsulfate and the like.

Non-limiting examples of suitable biodegradable quaternary ammonium salts include N,N-di(tallo\,voyl-oxy-ethyl)-N,N-dimethyl ammonium methyl sulfate and N,N-di(tallowoyl-oxy-propyl)-N,N-dimethyl ammonium methyl sulfate. Other suitable biodegradable quaternary ammonium salts are notably described in U.S. Pat. Nos. 4,137,180, 4,767,547 and 4,789,491.

In a preferred embodiment of the composition (C) according to the present invention, the cationic surfactant is an acyclic quaternary ammonium salt of the formula VH:

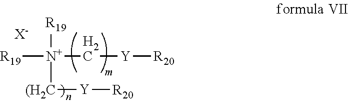

wherein each R₁₉ group is independently selected and at each occurrence from C1 to C4 alkyl, hydroxyalkyl or C2 to C4 alkenyl groups; k is selected from chloride, bromide, methyl sulfate, formate, sulfate, nitrate or any other suitable ion; Y is selected from —CH₂—, —O—C(O)— or —C(O)—O—; and wherein each R₂₀ group is independently selected and at each occurrence from C8 to C28 alkyl or alkenyl groups; and n and m are integers from 0 to 5.

Non-limiting examples of suitable commercially available acyclic quaternary ammonium salt cationic surfactants for use in the present invention include the Arquad® series from Akzo Nobel, the StepanTex® and Rewoquat® series from Evonik, KaoSoft series from Kao Chemicals.

In an alternative embodiment of the composition (C) according to the present invention, the cationic surfactant is an acyclic quaternary ammonium salt of the formula VIII:

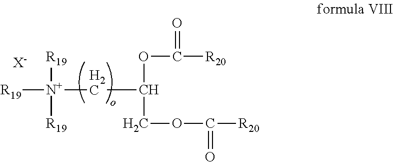

wherein X⁻, R₁₉ and R₂₀ have the same meaning as defined above for formula VH and wherein o is an integer from 0 to 5.

Without being bound to this theory, the inventors believe that the cationic surfactant, as detailed above, aids in the dissolution of the carbohydrate ester fragrance fixatives, as detailed above.

As said, the weight percent of the water in the composition (C) according to the present invention, relative to the total weight of composition (C), is at least 50.0 wt. % of water, or at least 60.0 wt. %, or at least 65.0 wt. %, or at least 70.0 wt. %, or at least 75.0 wt. %.

It is further understood that the upper limit of the amount of water in the composition (C) according to the present invention is advantageously equal to or less than 98.5 wt. %, or equal to or less than 97,0 wt. %, or equal to or less than 96.0 wt. %, or equal to or less than 95.5 wt. %, or equal to or less than 95.0 wt. %.

In a preferred embodiment of the composition (C) according the present invention, the weight percent of water ranges from 50.0 wt. % to 98.5 wt. %, or from 60.0 wt. % to 97.0 wt. %, or from 70,0 wt. % to 96.8 wt. %, or from 75.0 wt. % to 95.0 wt. %.

According to certain embodiments, the composition (C) according to the present invention, further comprises at least one solvent.

Among solvents suitable for use in the composition (C) according to the present invention, mention may be notably made of: ethanol, n-propanol, isopropanol, glycerol, propylene glycol_{;} diethylene glycol, dipropylene glycol, hexylene glycol, ethoxylates, fatty acids, triglycerides or fatty esters.

Typically, the amount of the solvent, when present, is from 0,01 wt. % to 20.0 wt. %, or from 0.02 wt. % to 15.0 wt. %, or from 0.05 wt. % to 10.0 wt. %, or from 0.1 wt. % to 5.0 wt. %, relative to the total weight of the composition (C).

According to certain embodiments, the composition (C) according to the present invention, further comprises at least one pH modifier.

Among pH modifiers suitable for use in the composition (C) according to the present invention, mention may be notably made of: hydrochloric acid, lactic acid, citric acid, acetic acid, tartaric acid, succinic acid, malic acid or lactic acid. Typically, the amount of the pH modifier, when present, is from 0.05 wt. % to 15.0 wt. %, or from 0.1 wt. % to 10.0 wt. %, or from 0.2 wt. % to 7.5 wt. %, or from 0.5 wt. % to 5.0 wt. %, relative to the total weight of the composition (C).

In a preferred embodiment of the present invention, the composition (C) is having a pH from 1.0 to 5.0, or from 1.5 to 4.0 or from 2.0 to 3.5. According to certain other embodiments the composition (C) of the present invention may further comprise other common additional ingredients [ingredient (I), herein after] to enhance the appearance, storage, transport, handling and/or performance of the product. Said ingredients (I) are known to those skilled in the art of fabric care and fabric softener compositions. Typical ingredients (I) may include, but are not limited to, preservatives such as bactericides, germicides, amphoteric and nonionic surfactants such as carboxyl derivatives of imidazole, oxyethylated fatty alcohols, hydrogenated and ethoxylated castor oil, alkyl polyglycosides like decyl polyglucose and dodecylpolyglucose, fatty alcohols, fatty acid esters, fatty acids, ethoxylated fatty acid glycerides or fatty acid partial glycerides, pH buffering agents, inorganic or organic salts such as water-soluble potassium, sodium, calcium or magnesium salts, optical brighteners, fabric crisping agents, spotting agents, colorants, dyes such as shading dyes, direct dyes, acid dyes, hydrophobic dyes, reactive dyes or dye conjugates, dye fixing agents or dye transfer inhibitors, fatty complexing agents, co-softeners, perfume carriers, silicones, hydrotropes, anti-redeposition agents, son-release agents, polyelectrolytes, anti-shrinking agents, anti-wrinkle agents, anti-oxidants, anti-foaming agents, enzymes, reductive agents, viscosity control agents, sunscreens, anti-corrosion agents, drape imparting agents, anti-static agents, ironing aids, pearlisers and/or opacifiers, wet soiling reduction agents such as polyorganosiloxanes, natural oils extracts, processing aids such as electrolytes, hygiene agents such as anti-bacterials and antifungals and skin benefit agents.

Typically, the amount of the ingredient (I), when present, is from 0.05 wt. % to 20 wt. %, or from 0.1 wt. % to 10 wt. %, or from 0.1 wt. % to 5 wt. %, relative to the total weight of the composition (C).

Another aspect of the present invention is a method for the manufacturing of the composition (C), as detailed above.

It is further understood that all definitions and preferences, as described above, equally apply for all further embodiments, as described below.

The composition (C) of the present invention can be prepared by a variety of methods known in the art In one embodiment of the present invention, the method for the manufacturing of the composition (C), as detailed above, comprises intimate admixing of the at least one fragrance fixative comprising at least one carbohydrate ester, as detailed above, wherein said carbohydrate ester is optionally dissolved in a solvent, the at least one fragrance, as detailed above, the at least one cationic surfactant, as detailed above, water and any optional ingredients such as a solvent, pH modifiers, ingredients (I), as detailed above.

Typically said intimate admixing may be carried out by using traditional mixers and blenders, high intensity mixers and electric stirrers.

It is understood that the skilled person in the art will carry out said intimate admixing according to general practice such as notably using the optimal order of addition, optimal times, speeds, weights, volumes and batch quantities.

In a preferred embodiment of the present invention, the method for the manufacturing of the composition (C), as detailed above, comprises in a first step premixing the at least one fragrance fixative comprising at least one carbohydrate ester, as detailed above, wherein said carbohydrate ester is optionally dissolved in a solvent, with the at least one fragrance, as detailed above, to obtain a premix (P), in a second step the premix (P) is intimately admixed with the at least one cationic surfactant, as detailed above, water and any optional ingredients.

Among solvents suitable for dissolving the carbohydrate esters, as detailed above, mention may be notably made of ethanol, isopropyl alcohol, n-propyl alcohol, n-butyl alcohol, isobutyl alcohol, caprylicicapric triglycerides or mixtures of two or more thereof.

In one embodiment of the composition (C) according to the present invention, the at least one carbohydrate ester is delivered from a solution comprising the at least one carbohydrate ester, as detailed above, and a suitable solvent, as detailed above, in a weight ratio from 0,01:100 to 1:100, or from 2:1 to 1:40, or from 1:1 to 1:20.

A non-limiting example of a commercially available carbohydrate ester dissolved in a solvent suitable for use in the composition (C) according to the present invention is Sustane™ SAIB ET-10 available from Eastman Chemical Company.

A further aspect of the present invention is the use of the composition (C), as detailed above, as an aqueous fabric softener composition in a laundry process.

The composition (C) is preferably for use in the rinse cycle of a home textile laundering operation, where, it may be added directly in an undiluted state to a washing machine, for example through a dispenser drawer or, for a top-loading washing machine, directly into the drum. The compositions (C) may also be used in domestic hand-washing laundry operations. It is also possible for the composition (C) of the present invention to be used in industrial laundry operations, for example as a finishing agent for softening and perfuming new clothes prior to sale to consumers.

### Experimental Results

The invention will be now described in more details with reference to the following examples, whose purpose is merely illustrative and not intended to limit the scope of the invention.

### Examples 1-3 and Comparative Example 4

### Materials and Methods:

Aqueous fabric softener compositions (C) according to the present invention were prepared by adding different amounts of a fragrance fixative according to the present invention, sucrose acetate isobutyrate available as SAIB-100 from Eastman Chemical Company, to a commercially available fabric softener composition “Silan Fris Lentegevoel (cone)” available in Belgium from Henkel. The commercial fabric softener composition comprises a cationic surfactant, fragrances and water within the limits according to the present invention.

Prior to mixing, the highly viscous sucrose acetate isobutyrate (i.e. SAIB, carbohydrate ester fragrance fixative) was heated to 50° C. Different amounts of the SAIB were poured into glass jars containing the commercial fabric softener Silan to obtain end concentrations of 0.5, 2.0 and 5.0 wt. % of fragrance fixative SAIB, relative to the total weight of the composition (C) (Examples 1, 2 and 3, respectively). As a comparative example, one glass jar only contained the commercial fabric softener Sian without the fragrance fixative SAIB. The mixtures were heated to 50° C. and shaken thoroughly on a bench shaker to obtain a homogenous emulsion. The discontinuous phase in the emulsion was dispersed into very fine droplets by mechanically agitating the emulsion in a dispersing machine (IKA-T25 Digital ULTRA-TURRAX, IKA, Germany) at 20,000 rpm for 15 minutes.

Eight cotton towels were used to evaluate the performance of aqueous fabric softener compositions (C) according to the present invention. The cotton towels were laundered in pairs using a Miele SOFTTRONIC W 667 washing machine at 40° C. (short cycle) and dried in a Miele T1 tumble dryer. The washing machine was loaded with recommended dosages of a commercially available liquid laundry detergent and the aqueous fabric softener compositions (C) or the pure commercial fabric softener.

### Results:

The laundered towels were evaluated on the following criteria: softness (S), fragrance intensity (I), and fragrance characteristics (C). Prior to the first evaluation, the towels were conditioned overnight at room temperature. All panelists were chosen based on the objective of consumer testing, however, none of them were qualified or trained to perform sensory evaluations. Each panelist was given four towels treated with compositions (C) comprising different concentrations of the fragrance fixative or with the pure commercial fabric softener. The towel samples were completely randomized. Panelists had to rank the towels from least (1) to most soft (4), from mildest (1) to most fragrant (4), and from least (1) to most pleasantly fragrant (4). This means that the panelists were asked both to provide preference judgment and to rate the fragrance on its intensity. The task was a forced ranking of the four towels, the results are shown in Table 1 below.

The towel of Example 3, laundered with the composition (C) comprising 5.0 wt% of the fragrance fixative, was evaluated as significantly more fragrant (i.e. I=3.4 on average) than the towels of Example 1 and 2 (i.e. washed with a composition (C) comprising 0.5 and 2.0 wt. % of the fragrance fixative, respectively and I=2.6), whereas the towel of Comparative Example 4, laundered with only the pure fabric softener in the absence of a fragrance fixative, was evaluated as significantly less fragrant (i.e. I=1.4 on average).

TABLE 1

| | | | | | | | | | | Comparative | | |
|---|---|---|---|---|---|---|---|---|---|---|---|---|
| Towel | Example 1 | | | Example 2 | | | Example 3 | | | Example 4 | | |
| Fragrance | 0.5 | | | 2.0 | | | 5.0 | | | 0.0 | | |
| fixative (wt %) | | | | | | | | | | | | |
| Criterion | S | I | C | S | I | C | S | I | C | S | I | C |
| Panelist | | | | | | | | | | | | |
| 1 | 2 | 2 | 1 | 1 | 3 | 4 | 4 | 4 | 2 | 3 | 1 | 3 |
| 2 | 3 | 2 | 4 | 1 | 4 | 3 | 2 | 3 | 2 | 4 | 1 | 1 |
| 3 | 3 | 4 | 2 | 1 | 2 | 3 | 2 | 3 | 4 | 4 | 1 | 1 |
| 4 | 1 | 4 | 1 | 2 | 1 | 2 | 4 | 3 | 4 | 3 | 2 | 3 |
| 5 | 3 | 3 | 4 | 1 | 2 | 3 | 2 | 4 | 2 | 4 | 1 | 1 |
| 6 | 1 | 1 | 1 | 2 | 4 | 4 | 3 | 3 | 2 | 4 | 2 | 3 |
| 7 | 2 | 2 | 4 | 1 | 1 | 2 | 3 | 4 | 1 | 4 | 3 | 3 |
| 8 | 1 | 3 | 3 | 4 | 1 | 1 | 3 | 4 | 4 | 2 | 2 | 2 |
| 9 | 2 | 2 | 2 | 4 | 3 | 4 | 3 | 4 | 3 | 1 | 1 | 1 |
| 10 | 4 | 2 | 2 | 2 | 4 | 1 | 1 | 3 | 3 | 3 | 1 | 4 |
| 11 | 4 | 2 | 2 | 3 | 3 | 3 | 2 | 4 | 4 | 1 | 1 | 1 |
| 12 | 4 | 4 | 4 | 1 | 3 | 3 | 3 | 2 | 2 | 2 | 1 | 1 |
| Sum | 30 | 31 | 30 | 23 | 31 | 33 | 32 | 41 | 33 | 35 | 17 | 24 |
| Average | 2.5 | 2.6 | 2.5 | 1.9 | 2.6 | 2.8 | 2.7 | 3.4 | 2.8 | 2.9 | 1.4 | 2.0 |
| StDev | 1.2 | 1.0 | 1.2 | 1.2 | 1.2 | 1.1 | 0.9 | 0.7 | 1.1 | 1.2 | 0.7 | 1.1 |
| Variance | 1.4 | 1.0 | 1.5 | 1.4 | 1.4 | 1.1 | 0.8 | 0.4 | 1.1 | 1.4 | 0.4 | 1.3 |

The same test was performed after storing the towels for 14 days at room temperature in a ventilated room, the results are shown in Table 2 below. The general feedback from the panel was that the differences in terms of softness and fragrance were perceived to be smaller compared with those observed in the first test. The data in Table 2 indicate that the towel laundered with only the pure fabric softener (Comp. Ex. 4) was found to have a lower fragrance intensity compared to the other towels which were laundered with an aqueous fabric softener composition (C).

TABLE 2

| | | | | | | | | | | Comparative | | |
|---|---|---|---|---|---|---|---|---|---|---|---|---|
| Towel | Example 1 | | | Example 2 | | | Example 3 | | | Example 4 | | |
| Fragrance | 0.5 | | | 2.0 | | | 5.0 | | | 0.0 | | |
| fixative (wt %) | | | | | | | | | | | | |
| Criterion | S | I | C | S | I | C | S | I | C | S | I | C |
| Panelist | | | | | | | | | | | | |
| 1 | 4 | 2 | 3 | 2 | 4 | 2 | 3 | 3 | 1 | 1 | 1 | 4 |
| 2 | 3 | 4 | 4 | 1 | 2 | 2 | 4 | 3 | 3 | 2 | 1 | 1 |
| 3 | 4 | 2 | 2 | 1 | 4 | 4 | 3 | 3 | 3 | 2 | 1 | 1 |
| 4 | 4 | 3 | 4 | 3 | 4 | 3 | 2 | 2 | 2 | 1 | 1 | 1 |
| 5 | 4 | 4 | 4 | 3 | 2 | 2 | 1 | 3 | 3 | 2 | 1 | 1 |
| 6 | 3 | 3 | 3 | 4 | 4 | 4 | 2 | 1 | 2 | 1 | 2 | 1 |
| 7 | 2 | 1 | 4 | 1 | 4 | 3 | 3 | 2 | 1 | 4 | 3 | 2 |
| 8 | 4 | 1 | 2 | 3 | 4 | 4 | 2 | 2 | 1 | 1 | 3 | 3 |
| 9 | 4 | 3 | 3 | 2 | 4 | 4 | 3 | 2 | 2 | 1 | 1 | 1 |
| 10 | 2 | 3 | 3 | 4 | 4 | 4 | 1 | 2 | 2 | 3 | 1 | 1 |
| 11 | 1 | 4 | 3 | 4 | 3 | 4 | 2 | 3 | 2 | 3 | 1 | 2 |
| 12 | 4 | 4 | 4 | 1 | 1 | 1 | 3 | 1 | 1 | 2 | 2 | 2 |
| Sum | 39 | 34 | 39 | 29 | 40 | 37 | 29 | 27 | 23 | 23 | 18 | 20 |
| Average | 3.3 | 2.8 | 3.3 | 2.4 | 3.3 | 3.1 | 2.4 | 2.3 | 1.9 | 1.9 | 1.5 | 1.7 |
| StDev | 1.0 | 1.1 | 0.7 | 1.2 | 1.0 | 1.0 | 0.9 | 0.7 | 0.8 | 1.0 | 0.8 | 0.9 |
| Variance | 1.0 | 1.1 | 0.5 | 1.4 | 1.1 | 1.1 | 0.7 | 0.5 | 0.6 | 0.9 | 0.6 | 0.9 |

1. An aqueous fabric softener composition [composition (C), herein after] comprising:
from 0.01 to 10.0 wt. % of at least one fragrance fixative comprising at least one carbohydrate ester;
from 0.01 to 10 wt. % of at least one fragrance;
from 1.0 to 50.0 wt. % of at least one cationic surfactant;
at least 45.0 wt. % of water;
wherein the fragrance fixative is characterized by a cLogP value of equal to or greater than 1.5 and a boiling point from 200° C. to 350° C.;
and wherein the carbohydrate ester comprises at least one ester group of formula —O—(C═O)—R₁ wherein R₁ is selected from C1-C6 alkyl or C1-C6 alkoxy groups;
and whereby the weight percentages are expressed relative to the total weight of the composition (C).

2. The composition (C) according to claim 1, wherein the weight percent of the at least one fragrance fixative, relative to the total weight of composition (C) is equal to or greater than 0.05 wt. %.

3. The composition (C) according to claim 1, wherein the cLogP value of the at least one fragrance fixative is equal to or greater than 1.65.

4. The composition (C) according to claim 1, wherein the boiling point of at least one fragrance fixative is equal to or greater than 200° C.

5. The composition (C) according to claim 1, wherein the fragrance fixative consists essentially of carbohydrate esters of general formula I: 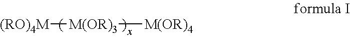
wherein:
each of M is independently selected and at each occurrence from monosaccharides in the pyranose or furanose form;
x is an integer in the range from 0 to 4;
each of R is independently selected and at each occurrence from —H or —(C═O)—R₁ wherein R₁ is selected from C1-C6 alkyl or C1-C6 alkoxy groups, with the proviso that at least one R is —(C═O)—R₁.

6. The composition (C) according to claim 1, wherein the fragrance fixative consists essentially of carbohydrate esters of formula II: 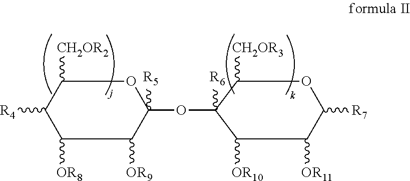
wherein:
each of R₂, R₃, R₈, R₉, R₁₀ and R₁₁ is independently selected and at each occurrence from —H or —(C═O)—R₁;
j and k are integers in the range of 0 to 1;
when j is 1, R₅ is —H and R₄ is OR₁₂ wherein R₁₂ is independently selected and at each occurrence from —H or —(C═O)—R₁;
when j is 0, R₄ is —CH₂OR₁₄ and R₅ is —CH₂OR₁₅ wherein R₁₄ and R₁₅ are independently selected and at each occurrence from —H or —(C═O)—R₁;
when k is 1, R₆ is —H and R₇ is OR₁₃ wherein R₁₃ is independently selected and at each occurrence from —H or —(C═O)—R₁;
when k is 0, R₆ is —CH₂OR₁₆ and R₇ is —CH₂OR₁₇ wherein R₁₆ and R₁₇ are independently selected and at each occurrence from —H or —(C═O)—R₁;
and wherein R₁ is selected from C1-C6 alkyl or C1-C6 alkoxy groups;
with the proviso that at least one of R₂, R₃, R₈, R₉, R₁₀, R₁₁, R₁₂, R₁₃, R₁₄, R₁₅, R₁₆ and R₁₇ is —(C═O)—R₁.

7. The composition (C) according to claim 1, wherein the fragrance fixative consists essentially of carbohydrate esters of formula III [carbohydrate esters of class (I), herein after]: 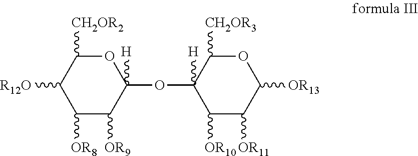
with the proviso that at least one of R₂, R₃, R₈, R₉, R₁₀, R₁₁, R₁₂ and R₁₃ is —(C═O)—R₁, wherein R₁, R₂, R₃, R₈, R₉, R₁₀, R₁₁, R₁₂ and R₁₃ have the same meaning as defined in claim 6 for formula II.

8. The composition (C) according to claim 1, wherein, the fragrance fixative consists essentially of carbohydrate esters of formula IV [carbohydrate esters of class (II), herein after]: 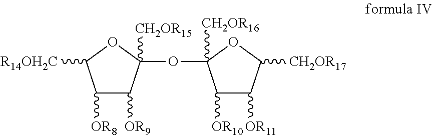
with the proviso that at least one of R₈, R₉, R₁₀, R₁₁, R₁₄, R₁₅, R₁₆ and R₁₇ is —(C═O)—R₁, wherein R₁, R₈, R₉, R₁₀, R₁₁, R₁₄, R₁₅, R₁₆ and R₁₇ have the same meaning as defined above in claim 6 for formula II.

9. The composition (C) according to claim 1, wherein the fragrance fixative consists essentially of carbohydrate esters of formula V [carbohydrate esters of class (III), herein after]: 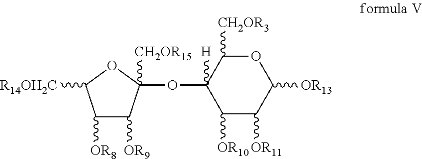
with the proviso that at least one of R₃, R₈, R₉, R₁₀, R₁₁, R₁₃, R₁₄ and R₁₅ is —(C═O)—R₁, wherein R₁, R₃, R₈, R₉, R₁₀, R₁₁, R₁₃, R₁₄ and R₁₅ have the same meaning as defined above in claim 6 for formula II.

10. The composition (C) according to claim 1, wherein the fragrance fixative consists essentially of carbohydrate esters of formula VI [carbohydrate esters of class (IV), herein after]: 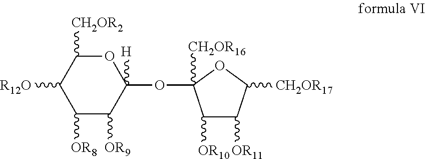
with the proviso that at least one of R₂, R₈, R₉, R₁₀, R₁₁, R₁₂, R₁₆ and R₁₇ is —(C═O)—R₁, wherein R₁, R₂, R₈, R₉, R₁₀, R₁₁, R₁₂, R₁₆ and R₁₇ have the same meaning as defined above in claim 6 for formula II.

11. The composition (C) according to claim 10, wherein carbohydrate esters of class (VI), for use in the composition (C) according to the present invention are those of formula VI-a herein below: 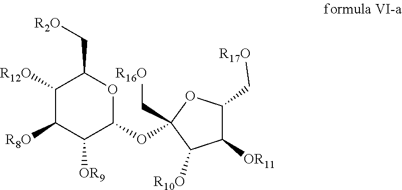
wherein:
each of R₂, R₈, R₉, R₁₀, R₁₁, R₁₂, R₁₆ and R₁₇ are independently selected and at each occurrence from —H or —(C═O)—R₁;
R₁ is selected from C1-C6 alkyl or C1-C6 alkoxy groups;
with the proviso that at least one of R₂, R₈, R₉, R₁₀, R₁₁, R₁₂, R₁₆ and R₁₇ is —(C═O)—R₁.

12. The composition (C) according to claim 1, wherein the weight percent of the at least one fragrance, relative to the total weight of composition (C) is equal to or greater than 0.02 wt. %, or equal to or greater than 0.05 wt. %, or equal to or greater than 0.1 wt. %, or equal to or greater than 0.15 wt. %, or equal to or greater than 0.2 wt. % and equal to or less than 8.0 wt. %, or equal to or less than 6.0 wt. %, or equal to or less than 4.0 wt. %, or equal to or less than 2.0 wt. %.

13. The composition (C) according to claim 1, wherein the weight percent of the at least one cationic surfactant, relative to the total weight of composition (C), is equal to or greater than 0.05 wt. %, or equal to or greater than 0.1 wt. %, or equal to or greater than 0.2 wt. %, or equal to or greater than 0.5 wt. %, or equal to or greater than 1.0 wt. % and equal to or less than 45.0 wt. %, or equal to or less than 40.0 wt. %, or equal to or less than 35.0 wt. %, or equal to or less than 30.0 wt. %.

14. A method for the manufacturing of the composition (C) according to claim 1, comprising in a first step premixing the at least one fragrance fixative comprising at least one carbohydrate ester, wherein said carbohydrate ester is optionally dissolved in a solvent, with the at least one fragrance, to obtain a premix (P); in a second step the premix (P) is intimately admixed with the at least one cationic surfactant, water and any optional ingredients.

15. (canceled)
